(19) United States
(12) Patent Application Publication
(10) Pub. No.: US 2007/0025515 A1
(43) Pub. Date: Feb. 1, 2007

(54) X-ray tube with cylindrical anode

(76) Inventors: Randol E. Kirk, Albuquerque, NM (US); Daniel F. Gorzen, Ypsilanti, MI (US)

Correspondence Address: Leo J. Aubel, 111 Rivershire Lane, Lincolnshire, IL, 60069, US

(21) Appl. No.: 11/190,985

(22) Filed: Jul. 27, 2005

(51) Int. Cl. H01J 35/00

(52) U.S. Cl. 378/121

(57) ABSTRACT

A linear source of x-rays is disclosed wherein an elongated filament, mounted within a cylindrically formed anode, provides electrons around the filament, and along the length of said filament. The anode that comprises a high Z material such as gold, receives the electrons and emits X-rays in a 360 degree arc and along a substantial length of the anode. In one embodiment the tube is used for irradiation purposes.

### BACKGROUND OF INVENTION

This patent application relates to apparatus wherein electrons bombard a transmission type target to develop X-rays that exit the opposite side of the target. Such transmission type targets are described in, for example, US Patent Application Publication No. 2002/0064253.

It is an object of the present invention to provide an X-ray tube having an elongated filament and a cylindrically shaped anode resulting in an X-ray tube that is much improved in power and efficiency over the prior art transmission type anodes.

### SUMMARY OF INVENTION

A source of X-ray beams is disclosed wherein the radiation field is developed by an elongated filament and a cylindrically shaped transmission type anode. The filament is mounted along the axis of the cylindrically shaped anode. The material of the anode and the energy of the electrons are selected to provide an anode wherein a majority of the electrons impinging on the interior surface of the anode are converted to X-rays which then penetrate the material of the anode and exit the anode. A portion of the electrons generate X-rays at the anode that are reflected from the anode and can be directed toward the target. The result is a linear source of X-rays providing high energy.

The foregoing features and advantages of the present invention will be apparent from the following more particular description of the invention. The accompanying drawings, listed herein below, are useful in explaining the invention.

### DESCRIPTION OF DRAWINGS

FIG. 1 is a drawing of the inventive X-ray tube;

FIG. 2 is a sketch of a cross sectional of the tube;

FIG. 3 is a sketch useful in explaining the radiation effect of the cylindrical anode; and

FIG. 4 is a sketch showing the 360 degree radiation field extending along the longitudinal length of the anode.

### DESCRIPTION OF INVENTION

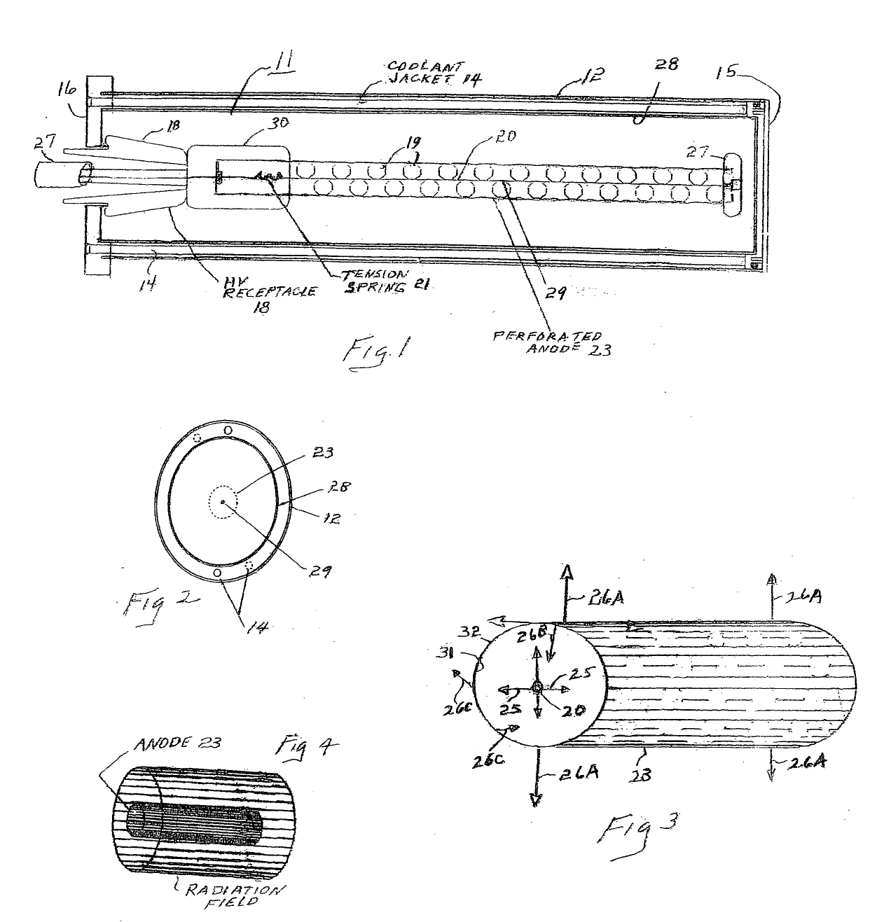

Refer first to FIG. 1, which shows one embodiment of an X-ray source or tube 11. Tube 11 comprises an outer cylinder-shaped housing 12 (see also FIG. 2) having a cap 15 suitably sealing one end of the housing. A second or flange end 16 of housing 12 receives a high voltage receptacle 18, of suitable known design. A second interior cylinder 28 is mounted within housing 12. The cylinder 28 is sealed at both ends to provided a closed member of minimum thickness and strength to enable the cylinder 28 to maintain a suitable vacuum, such as is known for high power vacuum tubes. A liquid coolant is provided to the tube 11 through a jacket 14 between cylinder 28 and housing 12.

The insulated high voltage receptacle 18 that is mounted on flange 16 receives the high voltage for powering the tube 12. In one embodiment, a suitable known type power supply, not shown, supplies 160 kV at 20 ma to the tube through cable 27.

A cathode support assembly 30 mounted at the end of receptacle 18 support an elongated and perforated anode 23, in the form of a cylinder. Anode 23 is mounted to extend from the cathode support 30 along the axis of cylinder 28. Perforations 19 in anode 23 are formed along the length of the anode. The free end of anode 23 is affixed onto a corona shield 27.

In one embodiment, the cylindrical anode 23 is formed of a layer of high Z (atomic number) material 31 such as gold, of about 10 microns thickness, that is deposited onto a surface of an aluminum outer layer of about 4 mils thickness. Other high Z material may be used in lieu of gold. A tungsten filament 29 is mounted on cathode support 30 and extends along the axis of anode 23. The base or cathode end of the filament 29 is connected through a tension spring 21 to the cathode support 30, and the other or free end of the filament is connected to a corona shield 27. Tension spring 21 maintains the filament 29 taut and compensates for the expansion that occurs when the filament is heated. Power for the filament 20 is provided through the high voltage leads 27.

Referring now also to FIG. 3, when the tungsten filament 29 is heated, electrons generally labeled 25 are generated. Importantly, the electrons 25 are emitted along substantially the full length of the centrally positioned filament 29. The electrons are emitted in 360 degree circle toward the biased cylindrical anode 23. The burst of a single plane of electrons is indicated in FIG. 3. In response to the electron bombardment, the anode 23 in turn develops X-rays in a 360 degree circle, as depicted in FIG. 3.

The energy of the electrons accelerated toward the anode 23 is correlated to the thickness of the anode material that comprises a gold deposition of 10 to 14 microns thickness on an aluminum material that is 4 mils thick. This factor improves the percentage of the electrons of a chosen acceleration that will convert to X-ray energy in the anode 23, and penetrate and exit the anode. As indicated in FIG. 3, the electrons 25 bombarding the interior gold layer surface of the anode 23 are converted to X-rays 26A which exit or pass through anode 23 while others of the electrons create X-rays 26B that are reflected back toward the axis of the anode and pass through an opposite surface of the anode. Once created, the X-rays can easily pass through the anode 23. Two important occurrence result: a) the creation of X-rays which proceed in a direction through the anode along the effective length of the anode 23, and b) the creation of X-rays which are reflected back occur along the effective length of the anode 23 and throughout the 360-degree circumference of the cylindrical anode, see FIG. 3.

The filament 20 and the anode 23 are both elongated thereby providing a cylindrical volume of electrons that are generated along the length of the filament. Importantly as mentioned above, this in turn results in a tube wherein X-rays are developed along the length of the anode 23, thereby providing a 360-degree radiation field along the length of the anode, as depicted in FIG. 4.

As stated above, in the inventive tube 11, electrons create X-rays that are emitted in a 360-degree arc from multiple points in the tube cylinder 12. The total dose of X-rays at a selected volume in space outside the tube cylinder will comprise:
1) the forward emission through the anode from a point nearest that target, and
2) an accumulation of X-rays reflected back to the target.

Also, a minor portion of the electrons 25 will create X-rays 26c from various other points on the anode surface that will be emitted and/or reflected at various angles; these random X-rays 26c will combine with the forward and reflected X-rays energy.

In tests it has been found that the irradiation of a prior art spot beam type system operating a 160 kV, 20 ma tube provided an average of 360R/min to a 28 square inch target. The inventive tube utilizing a 160 kV, 20 ma power supply provides an average of 3500R/min to a 62 square inch target which is about a ten (10)times increase in irradiation applied to a target double in size.

While the invention has been particularly shown and described with reference to a particular embodiment thereof it will be understood by those skilled in the art that various changes in form and detail may be made therein without departing from the spirit and scope of the invention.

1. An X-ray tube for providing an efficient source of X-rays, said tube comprising,
a) a cathode assembly including an elongated filament for providing electrons throughout 360-degrees around its longitudinal axis, and said filament providing electrons along a majority of its linear length;
b) an elongated cylindrical anode formed of a high Z material, said anode being powered to attract electrons from said filament to impinge thereon;
c) said filament being mounted along the axis of said cylindrical anode; and
d) said anode having a layer of a high Z material to cause a major portion of the electrons impinging thereon to convert to X-rays, to pass through said anode, and to exit as X-rays.

2. A X-ray tube comprising
a) an elongated filament for providing an elongated array of electrons;
b) an elongated cylindrical anode, said filament mounted along the axis of said cylindrical anode; and
c) said anode being powered to acquire the electrons from said filament and to develop X-rays in response thereto, said X-rays passing through said anode to provide a volume of X-rays along a linear portion of the anode.

3. An X-ray tube as in claim 2 wherein said anode comprises a layer of high Z material whereby a high majority of said electrons are converted to X-rays.

4. An X-ray tube as in claim 3 wherein said anode is formed of gold deposit ten microns in thickness deposited on an aluminum layer.

5. An X-ray tube as in claim 2 wherein said high Z material and the thickness thereof is selected with reference to the power applied to said anode to maximize the X-ray output of said anode.

6. A X-ray tube comprising
a) an elongated cylindrical anode,
b) an elongated filament mounted along the axis of said cylindrical anode;
c) means for energizing said filament, said filament providing an elongated array of electrons that fan out toward said anode;
d) means for powering said anode to acquire the electrons from said filament and to develop X-rays in response thereto, some of said X-rays passing through said anode to provide an array of X-rays along a linear portion of the anode.

7. An X-Ray tube as in claim 6 wherein said anode is of a high Z-material.

8. An X-Ray tube as in claim 6 wherein said anode is of a high Z material to allow electrons impinging thereon to pass through said anode and be converted to X-Rays.

9. An X-Ray tube as in claim 8 wherein some of said electrons impinging on said anode are reflected back and increase the energy provided by the anode to a given target.

10. An X-Ray tube as in claim 6 wherein said anode comprises a gold deposition on an aluminum material.
